(19) United States
(12) Patent Application Publication
(10) Pub. No.: US 2011/0237274 A1
(43) Pub. Date: Sep. 29, 2011

(54) MOBILE COMPUTING DEVICE HAVING RELATIVE POSITIONING CIRCUIT

(75) Inventors: Kean Wong, Redwood City, CA (US); Kevin Morishige, Los Altos Hills, CA (US)

(73) Assignee: Palm, Inc.

(21) Appl. No.: 12/731,490

(22) Filed: Mar. 25, 2010

(51) Int. Cl. H04W 88/02; H04W 64/00

(52) U.S. Cl. 455/456.1; 455/566

(57) ABSTRACT

A mobile computing device comprises a housing, a telephony circuit and a relative positioning circuit. The housing is configured to be held in a hand during use. The telephony circuit is coupled to the housing and is configured to communicate wireless telephony signals. The relative positioning circuit is coupled to the housing and is configured to determine at least one of a distance and a bearing to an object based on wireless signals received from the object.

### BACKGROUND

Some mobile computing devices use absolute position data to operate location based services, such as mapping programs, turn-by-turn navigation programs, etc. However, relative position data between the mobile computing device and an object may benefit some use scenarios.

### BRIEF DESCRIPTION OF THE DRAWINGS

FIG. 1 is a perspective view of a mobile computing device according to an exemplary embodiment.

FIG. 2 is a front view of the mobile computing device of FIG. 1 in an extended configuration according to an exemplary embodiment.

FIG. 3 is a back view of the mobile computing device of FIG. 1 in an extended configuration according to an exemplary embodiment.

FIG. 4 is a side view of the mobile computing device of FIG. 1 in an extended configuration according to an exemplary embodiment

FIG. 5 is a block diagram of the mobile computing device of FIG. 1 according to an exemplary embodiment.

FIG. 6 is a schematic diagram of a mobile computing device and an object, according to an exemplary embodiment.

FIG. 7 is a schematic diagram of a mobile computing device and an object in a vehicle environment, according to an exemplary embodiment.

FIG. 8 is a schematic diagram of a mobile computing device and a plurality of nearby objects, according to an exemplary embodiment.

FIG. 9 is a schematic diagram of a system and method of using relative position and a database to triangulate position will be described.

FIG. 10 is a schematic diagram of a system and method of using relative position to a fixed position

### DETAILED DESCRIPTION

Some embodiments described herein can avoid the need for infrastructure requirements and configuration challenges associated with an internet connection needed for some absolute positioning determinations. Some embodiments described herein can avoid the cost and design limitations of some absolute positioning systems. Some embodiments herein can use a point-to-point communications link between a mobile computing device and an object to allow relative position determination. Some embodiments described herein can allow file transfer between a mobile computing device and an object using relative position data to identify the desired destination object for the file transfer. Some embodiments can change features or parameters of a smart phone when the smart phone's approximate location is known (e.g., in a home, in an office, in a vehicle, etc.) based on relative position data. These and other features and embodiments will be described herein below.

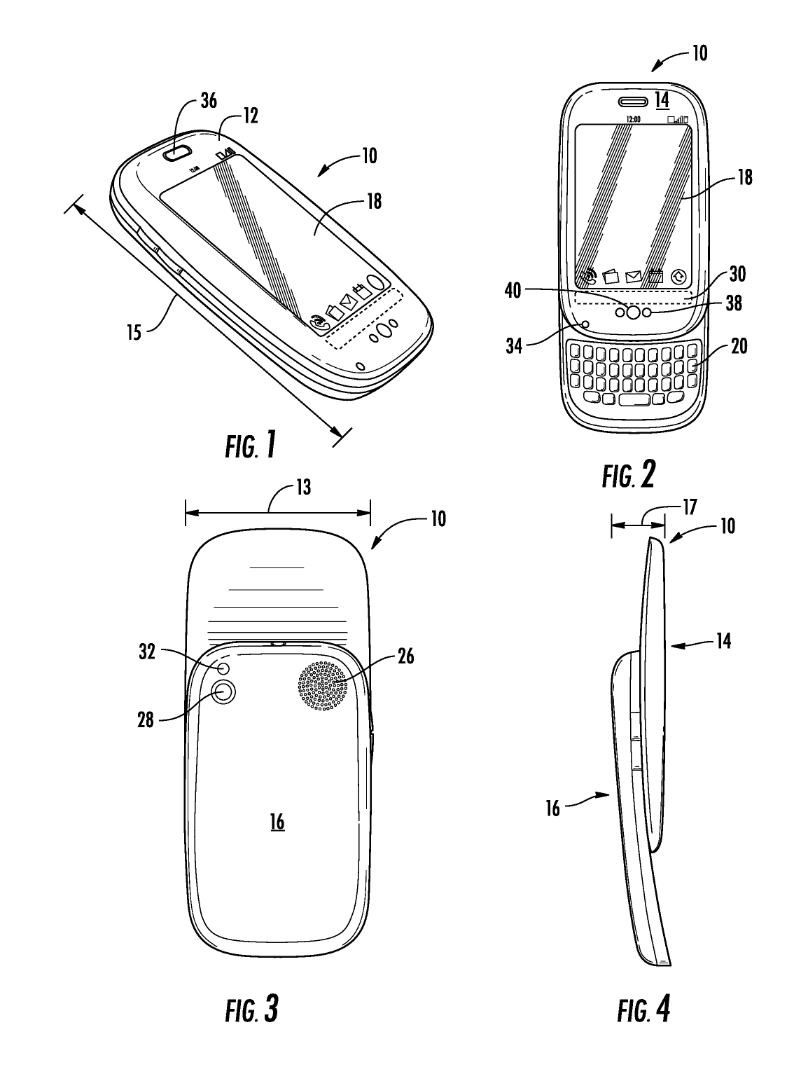

Referring to FIGS. 1-4, a mobile device 10 is shown. The teachings herein can be applied to device 10 or to other electronic devices (e.g., a desktop computer), such as mobile computing devices (e.g., a laptop computer) or handheld computing devices, such as a personal digital assistant (PDA), smartphone, mobile telephone, personal navigation device, handheld digital camera, handheld relative navigation device, etc. According to one embodiment, device 10 may be a smartphone, which is a combination mobile telephone and handheld computer having PDA functionality. PDA functionality can comprise one or more personal information management applications (e.g., including personal data applications such as email, calendar, contacts, etc.), database functions, word processing, spreadsheets, voice memo recording, Global Positioning System (GPS) functionality, etc. Device 10 may be configured to synchronize (e.g., two-way file synchronization) personal information from these applications with a computer (e.g., a desktop, laptop, server, etc.). Device 10 may be further configured to receive and operate additional applications provided to device 10 after manufacture, e.g., via wired or wireless download (such as from an “application store” operable on remote server computers), Secure Digital card, etc.

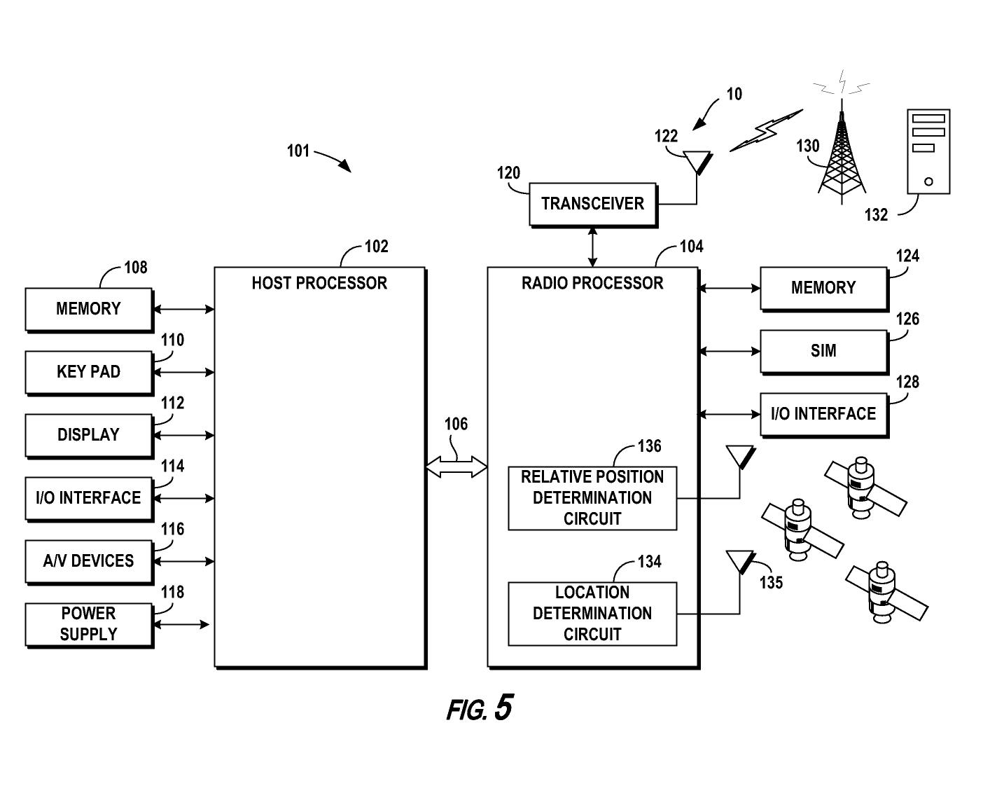

As shown in FIGS. 1-4, device 10 includes a housing 12 and a front 14 and a back 16. Device 10 further comprises a display 18 and a user input device 20 (e.g., a QWERTY keyboard, buttons, touch screen, microphone for speech recognition engine, etc.). Display 18 may comprise a touch screen display in order to provide user input to a processor 102 (see FIG. 5) to control functions, such as to select options displayed on display 18, enter text input to device 10, or enter other types of input. Display 18 also provides images (e.g., a geographic map, application icons, a web browser, etc.) that are displayed and may be viewed by users of device 10. User input device 20 can provide similar inputs as those of touch screen display 18. An input button 40 may be provided on front 14 and may be configured to perform pre-programmed functions. Device 10 can further comprise a speaker 26, a stylus (not shown) to assist the user in making selections on display 18, a camera 28, a camera flash 32, a microphone 34, and an earpiece 36. Display 18 may comprise a capacitive touch screen, a mutual capacitance touch screen, a self capacitance touch screen, a resistive touch screen, a touch screen using cameras and light such as a surface multi-touch screen, proximity sensors, or other touch screen technologies. Display 18 may be configured to receive inputs from finger touches at a plurality of locations on display 18 at the same time. Display 18 may be configured to receive a finger swipe or other directional input, which may be interpreted by a processing circuit to control certain functions distinct from a single touch input. Further, a gesture area 30 may be provided adjacent (e.g., below, above, to a side, etc.) or be incorporated into display 18 to receive various gestures as inputs, including taps, swipes, drags, flips, pinches, and so on, including multiple touch and multiple swipe commands (e.g., to zoom and/or pan an image such as a geographic map). One or more indicator areas 38 (e.g., lights, etc.) may be provided to indicate that a gesture has been received from a user.

According to an exemplary embodiment, housing 12 is configured to hold a screen such as display 18 in a fixed or movable (e.g., slidable, rotatable, hinged, etc.) relationship above a user input device such as user input device 20 in a substantially parallel or same plane, or in a different plane. This fixed relationship excludes a hinged or movable relationship between the screen and the user input device (e.g., a plurality of keys) in the fixed embodiment.

Device 10 may be a handheld computer, which is a computer small enough to be carried in a hand of a user, comprising such devices as typical mobile telephones and personal digital assistants, but excluding typical laptop computers and tablet PCs. The various input devices and other components of device 10 as described below may be positioned anywhere on device 10 (e.g., the front surface shown in FIG. 2, the rear surface shown in FIG. 3, the side surfaces as shown in FIG. 4, etc.). Furthermore, various components such as a keyboard etc. may be retractable to slide in and out from a portion of device 10 to be revealed along any of the sides of device 10, etc. For example, as shown in FIGS. 2-4, front 14 may be slidably adjustable relative to back 16 to reveal input device 20, such that in a retracted configuration (see FIG. 1) input device 20 is not visible, and in an extended configuration (see FIGS. 2-4) input device 20 is visible.

According to various exemplary embodiments, housing 12 may be any size, shape, and have a variety of length, width, thickness, and volume dimensions. For example, width 13 may be no more than about 200 millimeters (mm), 100 mm, 85 mm, or 65 mm, or alternatively, at least about 30 mm, 50 mm, or 55 mm. Length 15 may be no more than about 200 mm, 150 mm, 135 mm, or 125 mm, or alternatively, at least about 70 mm or 100 mm. Thickness 17 may be no more than about 150 mm, 50 mm, 25 mm, or 15 mm, or alternatively, at least about 10 mm, 15 mm, or 50 mm. The volume of housing 12 may be no more than about 2500 cubic centimeters (cc) or 1500 cc, or alternatively, at least about 1000 cc or 600 cc.

Device 10 may provide voice communications or telephony functionality in accordance with different types of cellular radiotelephone systems. Examples of cellular radiotelephone systems may include Code Division Multiple Access (CDMA) cellular radiotelephone communication systems, Global System for Mobile Communications (GSM) cellular radiotelephone systems, etc.

In addition to voice communications functionality, device 10 may be configured to provide data communications functionality in accordance with different types of cellular radiotelephone systems. Examples of cellular radiotelephone systems offering data communications services may include GSM with General Packet Radio Service (GPRS) systems (GSM/GPRS), CDMA/1xRTT systems, Enhanced Data Rates for Global Evolution (EDGE) systems, Evolution Data Only or Evolution Data Optimized (EV-DO) systems, Long Term Evolution (LTE) systems, etc.

Device 10 may be configured to provide voice and/or data communications functionality in accordance with different types of wireless network systems. Examples of wireless network systems may include a wireless local area network (WLAN) system, wireless metropolitan area network (WMAN) system, wireless wide area network (WWAN) system, and so forth. Examples of suitable wireless network systems offering data communication services may include the Institute of Electrical and Electronics Engineers (IEEE) 802.xx series of protocols, such as the IEEE 802.11a/b/g/n series of standard protocols and variants (also referred to as “WiFi”), the IEEE 802.16 series of standard protocols and variants (also referred to as “WiMAX”), the IEEE 802.20 series of standard protocols and variants, and so forth.

Device 10 may be configured to perform data communications in accordance with different types of shorter range wireless systems, such as a wireless personal area network (PAN) system. One example of a suitable wireless PAN system offering data communication services may include a Bluetooth system operating in accordance with the Bluetooth Special Interest Group (SIG) series of protocols, including Bluetooth Specification versions v1.0, v1.1, v1.2, v2.0, v2.0 with Enhanced Data Rate (EDR), as well as one or more Bluetooth Profiles, etc.

As shown in the embodiment of FIG. 5, device 10 may comprise a processing circuit 101 having a dual processor architecture including a host processor 102 and a radio processor 104 (e.g., a base band processor). The host processor 102 and the radio processor 104 may be configured to communicate with each other using interfaces 106 such as one or more universal serial bus (USB) interfaces, micro-USB interfaces, universal asynchronous receiver-transmitter (UART) interfaces, general purpose input/output (GPIO) interfaces, control/status lines, control/data lines, shared memory, and so forth.

The host processor 102 may be responsible for executing various software programs such as application programs and system programs to provide computing and processing operations for device 10. The radio processor 104 may be responsible for performing various voice and data communications operations for device 10 such as transmitting and receiving voice and data information over one or more wireless communications channels. Although embodiments of the dual processor architecture may be described as comprising the host processor 102 and the radio processor 104 for purposes of illustration, the dual processor architecture of device 10 may comprise additional processors, may be implemented as a dual- or multi-core chip with both host processor 102 and radio processor 104 on a single chip, etc.

In various embodiments, the host processor 102 may be implemented as a host central processing unit (CPU) using any suitable processor or logic device, such as a general purpose processor. The host processor 102 may comprise, or be implemented as, a chip multiprocessor (CMP), dedicated processor, embedded processor, media processor, input/output (I/O) processor, co-processor, a field programmable gate array (FPGA), a programmable logic device (PLD), or other processing device in alternative embodiments. In an exemplary embodiment, host processor 102 is an OMAP2, such as an OMAP2431 processor, manufactured by Texas Instruments, Inc.

The host processor 102 may be configured to provide processing or computing resources to device 10. For example, the host processor 102 may be responsible for executing various software programs such as application programs and system programs to provide computing and processing operations for device 10. Examples of application programs may include, for example, a telephone application, voicemail application, e-mail application, instant message (IM) application, short message service (SMS) application, multimedia message service (MMS) application, web browser application, personal information manager (PIM) application, contact management application, calendar application, scheduling application, task management application, word processing application, spreadsheet application, database application, video player application, audio player application, multimedia player application, digital camera application, video camera application, media management application, a gaming application, and so forth. The application software may provide a graphical user interface (GUI) to communicate information between device 10 and a user.

System programs assist in the running of the computer system. System programs may be directly responsible for controlling, integrating, and managing the individual hardware components of the computer system. Examples of system programs may include, for example, an operating system (OS), device drivers, programming tools, utility programs, software libraries, an application programming interface (API), graphical user interface (GUI), a username/password protection program, and so forth. Device 10 may utilize any suitable OS in accordance with the described embodiments such as a Palm webOS, Palm OS®, Palm OS® Cobalt, Microsoft® Windows OS, Microsoft Windows® CE, Microsoft Pocket PC, Microsoft Windows Mobile, Symbian OS™, Embedix OS, Linux, Binary Run-time Environment for Wireless (BREW) OS, JavaOS, a Wireless Application Protocol (WAP) OS, etc.

Device 10 may comprise a memory 108 coupled to the host processor 102 and a memory 124 coupled to the radio processor 104. In various embodiments, memories 108, 124 may be configured to store one or more software programs to be executed by the host processor 102 and/or radio processor 104. The memory 108 may be implemented using any machine-readable or computer-readable media capable of storing data such as volatile memory or non-volatile memory, removable or non-removable memory, erasable or non-erasable memory, writeable or re-writeable memory, and so forth. Examples of machine-readable storage media may include, without limitation, random-access memory (RAM), dynamic RAM (DRAM), read-only memory (ROM), flash memory, or any other type of media suitable for storing information.

Although the memory 108 may be shown as being separate from the host processor 102 for purposes of illustration, in various embodiments some portion or the entire memory 108 may be included on the same integrated circuit as the host processor 102. Alternatively, some portion or the entire memory 108 may be disposed on an integrated circuit or other medium (e.g., hard disk drive) external to the integrated circuit of host processor 102. In various embodiments, device 10 may comprise an expansion slot to support a multimedia and/or memory card, for example.

Device 10 may comprise a user input device 110 coupled to the host processor 102. The user input device 110 may comprise, for example, a QWERTY and/or alphanumeric key layout and an integrated number dial pad. Device 10 also may comprise various keys, buttons, and switches such as, for example, input keys, preset and programmable hot keys, left and right action buttons, a navigation button such as a multidirectional navigation button, phone/send and power/end buttons, preset and programmable shortcut buttons, a volume rocker switch, a ringer on/off switch having a vibrate mode, a keypad, an alphanumeric keypad, and so forth.

The host processor 102 may be coupled to a display 112. The display 112 may comprise any suitable visual interface for displaying content to a user of device 10. For example, the display 112 may be implemented by a liquid crystal display (LCD) such as a touch-sensitive color (e.g., 16-bit color) thin-film transistor (TFT) LCD screen. In some embodiments, the touch-sensitive LCD may be used with a stylus and/or a handwriting recognizer program.

Device 10 may comprise an input/output (I/O) interface 114 coupled to the host processor 102. The I/O interface 114 may comprise one or more I/O devices such as a serial connection port, an infrared port, integrated Bluetooth® wireless capability, and/or integrated 802.11x (WiFi) wireless capability, to enable wired (e.g., USB cable) and/or wireless connection to a local computer system, such as a local personal computer (PC). In various implementations, device 10 may be configured to transfer and/or synchronize information with the local computer system.

The host processor 102 may be coupled to various audio/video (A/V) devices 116 that support A/V capability of device 10. Examples of A/V devices 116 may include, for example, a microphone, one or more speakers, an audio port to connect an audio headset, an audio coder/decoder (codec), an audio player, a digital camera, a video camera, a video codec, a video player, and so forth.

The host processor 102 may be coupled to a power supply 118 configured to supply and manage power to the elements of device 10. In various embodiments, the power supply 118 may be implemented by a rechargeable battery, such as a removable and rechargeable lithium ion battery to provide direct current (DC) power, and/or an alternating current (AC) adapter to draw power from a standard AC main power supply.

As mentioned above, the radio processor 104 may perform voice and/or data communication operations for device 10. For example, the radio processor 104 may be configured to communicate voice information and/or data information over one or more assigned frequency bands of a wireless communication channel. In various embodiments, the radio processor 104 may be implemented as a communications processor using any suitable processor or logic device, such as a modem processor or base band processor. The radio processor 104 may comprise, or be implemented as, a digital signal processor (DSP), media access control (MAC) processor, or any other type of communications processor in accordance with the described embodiments. Radio processor 104 may be any of a plurality of modems manufactured by Qualcomm, Inc. or other manufacturers.

In various embodiments, the radio processor 104 may perform analog and/or digital base band operations for device 10. For example, the radio processor 104 may perform digital-to-analog conversion (DAC), analog-to-digital conversion (ADC), modulation, demodulation, encoding, decoding, encryption, decryption, and so forth.

Device 10 may comprise a transceiver module 120 coupled to the radio processor 104. The transceiver module 120 may comprise one or more transceivers configured to communicate using different types of protocols, communication ranges, operating power requirements, RF sub-bands, information types (e.g., voice or data), use scenarios, applications, and so forth. In various embodiments, the transceiver module 120 may comprise one or more transceivers configured to support voice communication for a cellular radiotelephone system such as a GSM, UMTS, CDMA, and/or LTE system. The transceiver module 120 also may comprise one or more transceivers configured to perform data communications in accordance with one or more wireless communications protocols such as WWAN protocols (e.g., GSM/GPRS protocols, CDMA/1xRTT protocols, EDGE protocols, EV-DO protocols, EV-DV protocols, HSDPA protocols, etc.), WLAN protocols (e.g., IEEE 802.11a/b/g/n, IEEE 802.16, IEEE 802.20, etc.), PAN protocols, Infrared protocols, Bluetooth protocols, EMI protocols including passive or active RFID protocols, and so forth.

The transceiver module 120 may be implemented using one or more chips as desired for a given implementation. Although the transceiver module 120 may be shown as being separate from and external to the radio processor 104 for purposes of illustration, in various embodiments some portion or the entire transceiver module 120 may be included on the same integrated circuit as the radio processor 104.

Device 10 may comprise an antenna system 122 for transmitting and/or receiving electrical signals. As shown, the antenna system 122 may be coupled to the radio processor 104 through the transceiver module 120. The antenna system 122 may comprise or be implemented as one or more internal antennas and/or external antennas.

Device 10 may comprise a subscriber identity module (SIM) 126 coupled to the radio processor 104. The SIM 126 may comprise, for example, a removable or non-removable smart card configured to encrypt voice and data transmissions and to store user-specific data for allowing a voice or data communications network to identify and authenticate the user. The SIM 126 also may store data such as personal settings specific to the user.

Device 10 may comprise an I/O interface 128 coupled to the radio processor 104. The I/O interface 128 may comprise one or more I/O devices to enable wired (e.g., serial, cable, etc.) and/or wireless (e.g., WiFi, short range, etc.) communication between device 10 and one or more external computer systems.

In various embodiments, device 10 may comprise location or position determination capabilities. Device 10 may employ one or more absolute position determination techniques including, for example, Global Positioning System (GPS) techniques, Cell Global Identity (CGI) techniques, CGI including timing advance (TA) techniques, Assisted GPS (AGPS) techniques, hybrid techniques, etc. A Wi-Fi Positioning System may be used as another type of absolute positioning system, such as one provided by Skyhook Wireless, Inc., Boston, Mass. For example, an absolute positioning circuit may be configured to collect Wi-Fi identifier data from a plurality of nearby Wi-Fi access points (e.g., any wireless transceiver communicating according to an IEEE 802.11x protocol) and retrieve a latitude/longitude or other absolute position from a database by looking up the Wi-Fi access point identifiers received in the position of interest. In another example, a Wi-Fi access point may be configured to transmit its absolute position and device 10 may be configured to determine that its absolute position is the position of the Wi-Fi access point, within a predetermined error. Another type of absolute positioning system having less accuracy than GPS is a Cell-ID triangulation positioning system, such as one provided by Telmap, Ltd., London, United Kingdom.

Referring again to FIG. 5, processing circuit 101 may comprise a relative position determination circuit 136, shown in exemplary form as a part of the radio processor 104, though circuit 136 may be part of host processor 102 or any other portion of processing circuit 101. The relative position determination circuit may comprise circuitry and/or software configured to provide relative position data for device 10 relative to an object (see FIG. 16). One exemplary technology for providing relative position data is the Indoor Navigation Platform produced by iSeeLoc, Inc., San Jose, Calif., described in U.S. Patent Pub. No. 2009/0251363 published Oct. 8, 2009 entitled “System and Method for Locating Items and Places,” which is incorporated herein by reference in its entirety. Alternative technologies for providing relative position data, including the use of absolute position circuits at both the mobile computing device and the nearby object, may be employed.

In various embodiments, device 10 may comprise dedicated hardware circuits or structures, or a combination of dedicated hardware and associated software, to support absolute and/or relative position determination. For example, the transceiver module 120 and the antenna system 122 may comprise GPS receiver or transceiver hardware and one or more associated antennas coupled to the radio processor 104 to support position determination.

The host processor 102 may comprise and/or implement at least one LBS (location-based service) application. In general, the LBS application may comprise any type of client application executed by the host processor 102, such as a GPS application, configured to communicate location requests (e.g., requests for position fixes) and location responses. Examples of LBS applications include, without limitation, wireless 911 emergency services, roadside assistance, asset tracking, fleet management, friends and family locator services, dating services, and navigation services which may provide the user with maps, directions, routing, traffic updates, mass transit schedules, information regarding local points-of-interest (POI) such as restaurants, hotels, landmarks, and entertainment venues, and other types of LBS services in accordance with the described embodiments.

Radio processor 104 also may set request/response parameters to request and return various types of position information. Examples of request/response parameters may include current location, latitude, longitude, altitude, heading, vector information such as horizontal and vertical velocity, sector-based position location, position fix method, level of accuracy, time offset, position uncertainty, device orientation, client initialization and registration, and so forth.

Use with Portable Items for Tracking

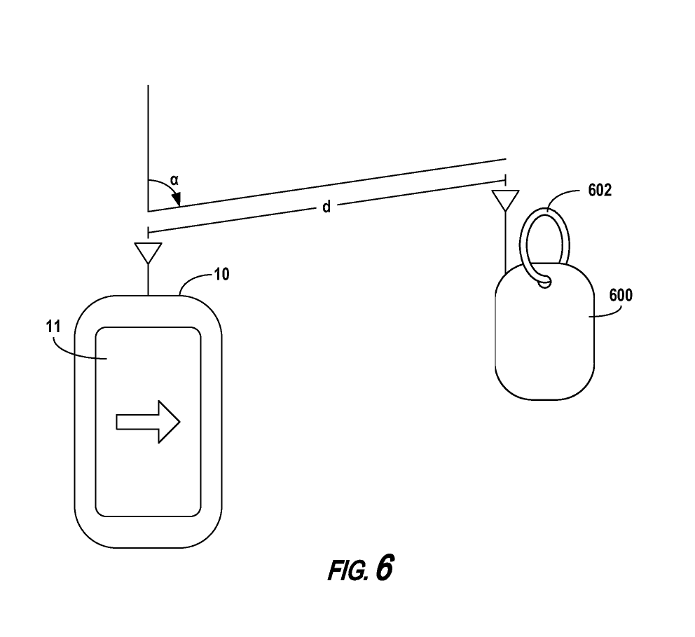

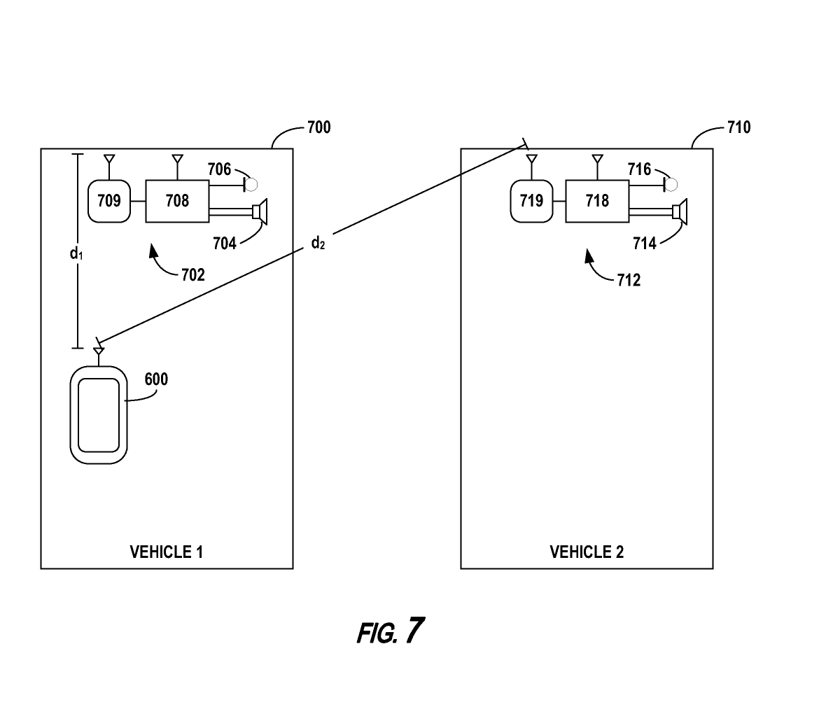

Referring first to FIG. 6, a schematic diagram is shown illustrating a mobile computing device and object for use in tracking portable items. In this embodiment, device 10 may be a smart phone comprising a touch screen display 11, which comprises a housing configured to be held in a hand during use and a telephony circuit coupled to the housing configured to communicate wireless telephony signals. Device 10 further comprises a relative positioning circuit coupled to the housing configured to determine at least one of a distance d and a bearing alpha to an object 600 based on wireless signals received from object 600. Object 600 comprises a housing and a coupling device 602 configured to be coupled to a portable item to be located. The coupling device 602 may comprise a metal ring or clip, a pin, a string through an aperture in the housing, an adhesive, a spring-biased clip, or any of a number of different mechanical coupling devices. The portable item may be a piece of luggage, a bicycle, a laptop, valuables, a beach towel, or other items designed to be portable or to be carried about by a person. According to various embodiments, object 600 can be less than about the size of a pack of playing cards, less than the size of a box of matches, about the size of a credit card, or any of the sizes described herein with respect to housing 12 of mobile device 10.

In operation, device 10 is configured to calculate, determine or generate at least one of a bearing or direction, a distance or range, and a change in altitude between device 10 and object 600. Device 10 is configured to receive wireless signals from object 100 and determine the bearing, distance, and/or change in altitude based on the wireless signals. According to one exemplary embodiment, device 10 and object 600 may comprise the system described in U.S. Patent Pub. No. 2009/0251363 entitled “System and Method for Locating Items and Places” to Zohar et al., which is incorporated by reference herein in its entirety. In this example, object 600 acts as a base unit including a first transceiver and a first set of printed circuit antennas. Device 10 comprises a second transceiver and a second set of printed circuit antennas and a circuit or module configured to calculate bearing to the base unit and to display the bearing on device 10. The transceivers may communicate using any transmission protocol, such as ZIGBEE, WiFi, Bluetooth, WiMax, etc., and may use frequency shift keying encoding. Either or both of the first and second sets of antennas may comprise an array of omni-directional antennas and/or a rotating antenna. The base unit sends a beacon signal used by the second transceiver to calculate a bearing. Doppler effect based measurements are used to calculate the bearing. The bearing is a cyclic average of bearing results. The bearing is computed over multiple transmitted carrier frequencies and transmitting antennas. The base unit may use an altimeter to report its altitude to device 10.

Alternative technologies for determining bearing, distance, and/or altitude difference between device 10 and object 600 may be used. For example, an ultra wideband radar circuit provided in or with each of device 10 and object 600 may be used. UWB transmissions transmit information by generating radio energy at specific time instants and occupying large bandwidth thus enabling a pulse-position or time-modulation. The information can also be imparted (modulated) on UWB signals (pulses) by encoding the polarity of the pulse, the amplitude of the pulse, and/or by using orthogonal pulses. As another example, ultrasonic wave circuits may be used. In other embodiments, any wireless signal having a wavelength, including light and sound, may be used to provide direction, including technologies used in marine and air navigation (which have the ability to provide relative direction to a source and may use Morse code to determine the nature of the radio source). CB radio signals may be modified to provide relative direction. In any of these embodiments, an altimeter may be used to provide indications of a third dimension.

A preferred communication technology would use a point-to-point communications link established to transfer information to allow accurate distance determination (sub meter) and bearing determination (5 degrees or less), and capable of tracking two or more objects. Preferably the transport would be one that has good propagation characteristics (e.g., 450 or 900 MHz ISM).

Other uses for the technology include tracking geographic location such as a campsite location or picnic table. In one embodiment, the system and method described herein may be used by emergency service responders to find people based on the location of their phone. Emergency services responders would have units capable of interacting with the devices and objects described herein, for example units that were physically larger and had more powerful transmit and more sensitive receive antenna arrays and modems. Emergency services could locate a person who was trapped, missing or in a dangerous situation (like in a burning building). Although E911 GPS will give approximate coordinates, it will not indicate whether or not a person is above, below or even nearby. If you know a person's relative position, you can narrow their actual location. In one embodiment, object 600 may be integrated within or coupled to a wall-mounted charging station, such as a wireless charging dock, such as the Palm Touchstone dock. When device 10 is set on the charging dock (and retained by magnetic and/or gravity forces), device 10 can use signals from object 600 to determine its location.

Referring now to FIG. 7, a schematic diagram of another embodiment will be described. A mobile device 10 is brought into a vehicle 700 by a user. The user wishes to use device 10 to communicate with vehicle 700, for example in a hands-free phone configuration or to communicate wireless data from mobile device 10 to a system of vehicle 700. Vehicle 700 comprises a hands-free phone system 702 comprising a speaker 704, a microphone 706 and a control circuit 708. In this exemplary embodiment, system 702 operates according to a short-range communication protocol, such as a Bluetooth protocol, which requires a pairing operation in which system 702 and device 10 exchange Bluetooth identifier data. A short-range wireless transceiver on device 10 detects a wireless transceiver coupled to system 702 and also system 712 of a nearby vehicle 710. However, device 10 is not provided with information indicating the distance between device 10 and systems 702 and 712.

Objects 709, 719, such as object 600 in FIG. 6, are coupled to each of systems 702 and 712, respectively. Objects 709 and 719 are configured to send wireless signals to device 10 which device 10 is configured to use to determine at least one of a distance and bearing between device 10 and objects 709, 719. Device 10 may be configured to determine that distance d1 to object 709 is smaller than distance d2 to object 719 and that, therefore, the signals from object 709 are associated with the system 702 that the user wishes device 10 to pair with. Objects 709, 719 may be configured to send the Bluetooth identifiers of systems 702, 712 to device 10, or other identifiers that device 10 may use to distinguish system 702 from system 712. According to one embodiment, identifiers received from each of objects 709, 719 may be displayed on a display of device 10 along with an approximation of distances d1, d2, and device 10 may be configured to receive a selection from the user of the system 702 or 712 that should be paired with device 10. These embodiments may help distinguish two side-by-side cars in a garage or parking lot wherein device 10 may be confused regarding which car to pair to.

Objects 709, 719 may be separate modules from systems 702, 712 or the components thereof may be integrated with the electronic components (e.g., a processor, discrete digital and/or analog components, etc.) and mechanical components (e.g., a housing, connectors, etc.) of systems 708, 718. Objects 709, 719 may share an antenna with systems 702, 712, respectively.

According to another embodiment, device 10 may be configured to use object 709 to detect whether device 10 is in vehicle 700 (e.g., as opposed to an unknown location or other known location) and to change a feature or function of device 10 based on the detection or determination. In this embodiment, device 10 is configured to receive signals from object 709 to determine a distance to object 709. If the distance is less than a predetermined distance (e.g., less than 0.5 meters, less than 1 meter, etc.), device 10 may be configured to determine that it is located within vehicle 700. Device 10 may further be configured to detect a quantity of time that it is within the predetermined distance (E.g., greater than 10 seconds, greater than 1 minute, etc.) and determine that device 10 is within the vehicle if a predetermined distance criterion is met for a predetermined period of time. Based on the determination that device 10 is within vehicle 700, one or more features or functions of device 10 may be configured, set, or changed. For example, device may be configured to operate a wireless access program and the program may be configured to forgo establishing a communication link with nearby wireless access points based on the determination that device 10 is within vehicle 700. This feature may be advantageous to indicate that when device 10 is in a automobile, the device would ignore passing access points (e.g., Wi-Fi access points) as you drive.

According to another embodiment, device 10 may be configured to determine that the device 10 is at a predetermined location, such as a home, work, or second home. An object 600 may be placed within the predetermined location. When device 10 detects that it is within a predetermined distance, or in communication range, with object 600, device 10 may determine that it is at the predetermined location. Device 10 may use this information to determine that the device is in an approximate predetermined location. In response to this determination, device 10 may be configured to change a feature on at least one program operating on device 10. For example, if device 10 determines it is at a home location (e.g., as previously identified to the device by the user based on an identifier of object 600 disposed in the home), device 10 may be configured to allow access to device 10 without a password and/or username. A password program operable on device 10 may be configured to allow access to a portion or all of the functions of device 10 without requiring a password. As another example, device 10 may be configured to provide the location as a search parameter to a web-based application, such as an Internet search, map search, retail product search, etc., to assist device 10 with narrowing the search hits to those hits having a relationship to the location of the device 10 (e.g., pizza restaurants near the home vs. near work). As yet another example, a feature of a telephony application may be set based on the approximate location of the mobile computing device. For example, speed dial icons or keys can change from one set of phone numbers when at home to another set of phone numbers when at work. As another example, if device 10 determines it is at a home location, device 10 may be configured to forward cellular phone calls to a home phone number (e.g., a land line or POTS line). The same feature could be implemented for a work location and work phone number. As another example, device 10 could search for wireless access points (e.g., Wi-Fi APs) based on known location, by setting a search order to search for nearby WAPs first followed by WAPs of increasing distance from device 10. As another example, device 10 could be put into a silent mode when in proximity of devices with certain a pre-programmed code. This could apply to churches, in movie theaters, etc. Other scenarios are contemplated.

According to another exemplary embodiment, a predetermined location may contain a plurality of objects 600 disposed in different rooms, each having different identifiers, alone or in communication with Bluetooth pucks or transceivers operating according to a Bluetooth protocol. Device 10 may be configured to determine distance and/or bearing and/or altitude change to each of objects 600 based on signals transmitted by objects 600. Device 10 may then be configured to determine in which room of the predetermined location the device 10 is, and to further configure a feature or setting of one or more programs operable on device 10 based on the determination. For example, if device 10 determines it is in a living room, device 10 may be configured to adjust the lighting, HVAC, window shades, or other home systems of the room by sending wireless messages to other wireless devices coupled to control units for these home systems. Device 10 may be configured to send signals to a subset of all home systems based on the determination of the room within the house made using signals from objects 600. Another exemplary home system that may be controlled by device 10 is an audio/video or home entertainment system, in which device 10 may be configured to transmit a digital media file, such as a video, from device 10 to a device configured to play the media file on a television and/or speaker system. Device 10 may be configured to use determined bearing data to select from among several home entertainment systems in the same room or in adjoining rooms.

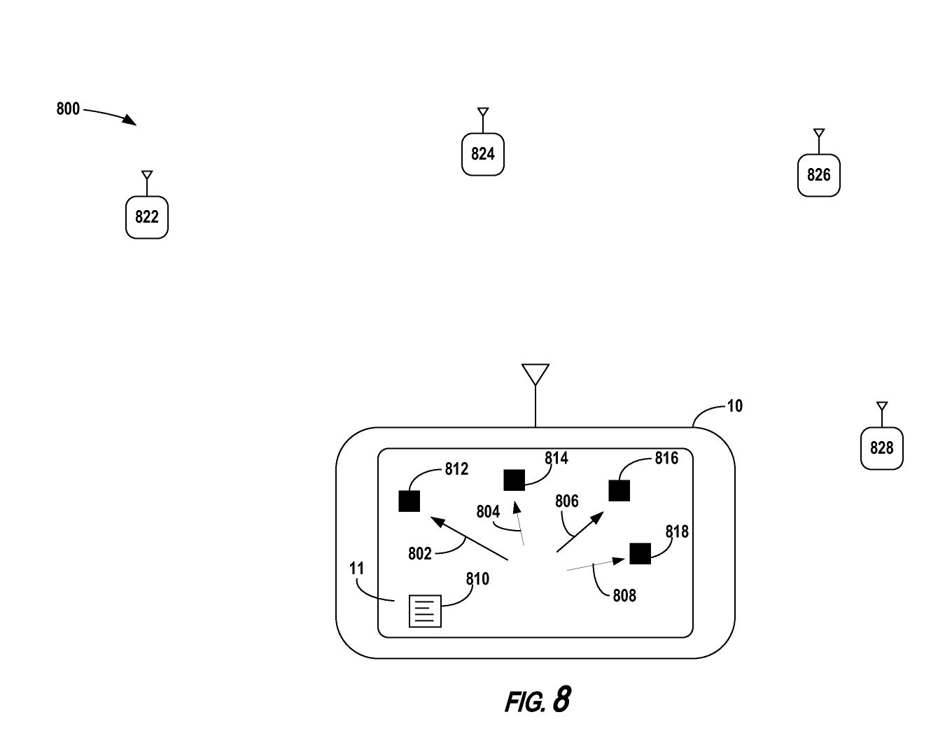

Referring now to FIG. 8, another exemplary embodiment will be described. A mobile computing device 10 comprises display 11 and a relative positioning circuit configured to determine bearings to a plurality of objects 800 based on wireless signals received from the objects. In this embodiment, display 11 is configured to display a graphic representation of the bearings, as shown by arrows 802, 804, 806 and 808. Display 11 also shows an icon 810 representing a file to be transferred wirelessly, such as a document, media file, digital photo, .mp3 file, contact file (comprising personal information about a person, as used in a contacts application), etc. Each of objects 800 comprises a transmitter such as described above with reference to object 600.

Device 10 further comprises a wireless transceiver, which may be the same one used for the relative position determination circuit or a different transceiver, to transmit a signal or data file to a subset (e.g. at least one) of the plurality of nearby objects based on a user input received. The user input may comprise a drag and drop of icon (or a “throw” swiping motion) in the direction of or onto one of icons 812, 814, 816 and 818 representing nearby objects 822, 824, 826 and 828, respectively. Optionally, distance and/or altitude change between device 10 and objects 800 may additional be displayed to assist the user in selecting the object to which the user wishes device 10 to send the signal. According to one aspect, the relative position determination circuit can act as an authentication and/or identification mechanism.

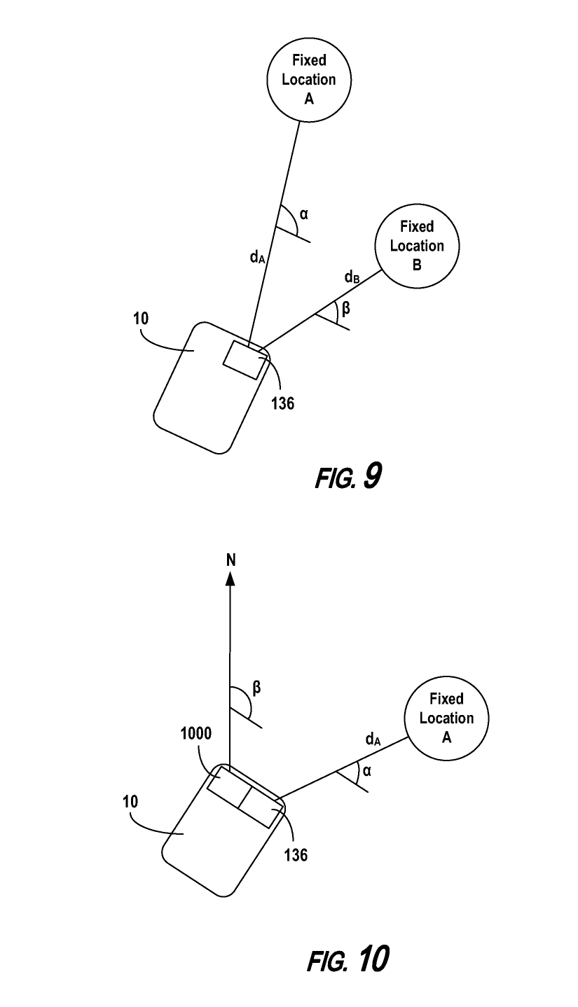

Referring now to FIG. 9, a system and method of using relative position and a database to triangulate position will be described. In this embodiment, relative position and a database can be used to triangulate with other points of interest that do not have the transponders in order to determine absolute position of the mobile device and/or relative position of the other points of interest to the mobile device. In the embodiment of FIG. 9, mobile device 10 comprises a relative position determination circuit 136 as described hereinabove. Device 10 also has access to a database of geographic information stored locally on a memory of device 10 or accessible via wireless communication with a remote server. Device 10 is configured to use circuit 136 to determine a relative position and orientation (angle alpha) to a fixed location A. Device 10 is then configured to retrieve an absolute position for fixed location A, for example expressed as a latitude/longitude, or other absolute position. Based on the absolute position for fixed location A and the relative position and orientation between device 10 and fixed location A, device 10 is configured to calculate an absolute position for device 10. The device orientation could be detected either through a magnetometer (compass) or by the positioning mechanism itself (as the angel Alpha will be relative to the orientation of the device). Further, device 10 may be configured to calculate a relative position between device 10 and a fixed location B which does not have a transponder circuit for relative position calculation. Device 10 may be configured to retrieve from a database an absolute position of fixed location B and, based on the known difference in absolute positions of fixed locations A and B, and on the relative location between device 10 and fixed location A, to calculate a relative location between device 10 and fixed location B. For example, if device 10 is 500 feet from point A, and it is 30 degrees North of device A, then device 10 can determine from the geographic information database that point B (which does not have a radio) is 50 degrees North, 300 feet away from device 10. In this way, absolute position may be determined by triangulating with two known fixed positions (using distance and angle to each one, relative to the device 10).

Referring to FIG. 10, a system and method of using relative position and a database to triangulate position will be described. In this embodiment, relative position and a database can be used to triangulate with one point of interest and True North, using a compass, in order to determine absolute position of the mobile device. In the embodiment of FIG. 10, mobile device 10 comprises a relative position determination circuit 136 as described hereinabove. Device 10 further comprises an electronic compass 1000. Compass 1000 may be configured to determine a direction or orientation of device 10 relative to Earth's magnetic poles. Compass 1000 may comprises solid state device, such as magneto-inductive, magneto-resistive, or other types of magnetic field sensors. Device 10 also has access to a database of geographic information. Device 10 is configured to use circuit 136 to determine a relative position and orientation (angle alpha) to a fixed location A. Device 10 is then configured to retrieve an orientation relative to True North or another reference direction to calculate an angle beta. Based on the absolute position for fixed location A and the orientation relative to True North, device 10 is configured to calculate an absolute position for device 10. For example, if device 10 is 500 feet away and 30 degrees north of point A (which is at a specific lat/long), and device 10 is pointing 60 degrees from north, then a specific lat/long for device 10 may be calculated. In this way, absolute position may be determined by triangulating with one known fixed positions (using distance and angle to the fixed location) and a compass on the device.

According to another exemplary embodiment, device 10 may be configured to allow a user to map an area. Device 10 is first configured to determine its distance and orientation to a known location or original point of reference (e.g., which may be a charging station for device 10 such as the Palm Touchstone charger having a known location previously stored in device 10 during charging). Device 10 then prompts user to point device 10 at other electronic devices, rooms, or other items or areas of interest in a building, such as a home or office (e.g., television, stereo, kitchen, etc.). Device 10 may then be configured to store and/or display a virtual map of where those items or areas of interest are located in a room or building relative to the original point of reference. Device 10 may then prompt the user to move to another room, such as a kitchen, or other portion of a room and point back or again to the same items or areas of interest. Device 10 may then store the orientation data from the compass and use it to calculate absolute position of the items or areas of interest. Device 10 then can be spatially aware of its environment and provide functions to the user based on this spatial awareness.

According to another exemplary embodiment, device 10 may be configured to map out a path (such as a walking path) from an initial point to a desired destination point based on relative position information. Device 10 may be configured to direct the user (via display, audio, vibrations, etc.) based on the relative position information to proceed in a certain direction and continuously change that direction as the user moves until the desired destination is reached.

Various embodiments disclosed herein may include or be implemented in connection with computer-readable media configured to store machine-executable instructions therein, and/or one or more modules, circuits, units, or other elements that may comprise analog and/or digital circuit components (e.g. a processor or other processing circuit) configured or arranged to perform one or more of the steps recited herein. By way of example, computer-readable media may include RAM, ROM, CD-ROM, or other optical disk storage, magnetic disk storage, flash memory, or any other medium capable of storing and providing access to desired machine-executable instructions. The use of circuit or module herein is meant to broadly encompass any one or more of discrete circuit components, analog and/or digital circuit components, integrated circuits, solid state devices and/or programmed portions of any of the foregoing, including microprocessors, microcontrollers, ASICs, programmable logic, or other electronic devices.

While the detailed drawings, specific examples and particular formulations given describe exemplary embodiments, they serve the purpose of illustration only. The hardware and software configurations shown and described may differ depending on the chosen performance characteristics and physical characteristics of the computing devices. The systems shown and described are not limited to the precise details and conditions disclosed. Furthermore, other substitutions, modifications, changes, and omissions may be made in the design, operating conditions, and arrangement of the exemplary embodiments without departing from the scope of the present disclosure as expressed in the appended claims.

1. A handheld computing device, comprising:
a housing;
a relative positioning circuit coupled to the housing configured to determine bearings to a plurality of objects based on wireless signals received from the objects;
a display configured to display a representation of the plurality of objects;
a user input device configured to receive a user input and a selection of a subset of the plurality of objects; and
a wireless transceiver configured to transmit a signal based on the user input wirelessly to the subset of the plurality of objects.

2. The handheld computing device of claim 1, wherein the signal comprises a data file comprising a contact file stored in a contacts application, wherein the contact file comprises personal information about a person.

3. The handheld computing device of claim 1, wherein the representation of the plurality of objects comprises a graphic representation comprising an arrow pointing in the direction of the objects based on the bearings.

4. The handheld computing device of claim 1, wherein the relative positioning circuit is further configured to determine a distance and altitude change to the objects and to display indications of at least the distances to the objects.

5. The handheld computing device of claim 1, wherein the signal comprises a data file comprising video or audio data.

6. The handheld computing device of claim 1, wherein the signal is configured to control an electronic system of a home or office.

7. A handheld computing device, comprising:
a telephony circuit configured to provide wireless telephony communications;
a processing circuit configured to receive wireless signals from an object, to determine at least one of a bearing, distance, or altitude change to the object based on the wireless signals, to determine an approximate location of the mobile computing device based on the wireless signals, and to change a feature on at least one program operating on the processing circuit based on the location determination.

8. The handheld computing device of claim 7, wherein the program is a password program, wherein a password is not required when the mobile computing device is in a predetermined location.

9. The handheld computing device of claim 7, wherein the program is a searching application, wherein at least one search parameter is set based on the approximate location of the mobile computing device.

10. The handheld computing device of claim 7, wherein the program is a telephony application, wherein at least one feature of the telephony application is set based on the approximate location of the mobile computing device.

11. The handheld computing device of claim 7, wherein the processing circuit is configured to determine that the mobile computing device is in an automobile based on the wireless signals.

12. The handheld computing device of claim 11, wherein the program is a wireless access program and the program is configured to forgo establishing a communication link with nearby wireless access points based on the determination.

13. The handheld computing device of claim 7, further comprising a short range wireless transceiver configured to exchange identifier data with another short range wireless transceiver disposed in an automobile, wherein the processing circuit is configured to determine that the mobile computing device is in an automobile based on the wireless signals from the object and to control the short range wireless transceiver to exchange identifier data with the other short range wireless transceiver based on the determination.

14. A system, comprising:
a handheld computing device, comprising:
a housing;
a telephony circuit coupled to the housing configured to communicate wireless telephony signals; and
a relative positioning circuit coupled to the housing configured to determine at least one of a distance and a bearing to an object based on wireless signals received from the object; and
the object, wherein the object comprises a coupling device configured to be coupled to a portable item to be located.

15. The handheld computing device of claim 14, wherein the relative positioning circuit is further configured to determine an altitude change to the object based on wireless signals received from the object.

16. The handheld computing device of claim 14, further comprising a processing circuit configured to operate a plurality of applications configured to manage personal information of a user.

17. The handheld computing device of claim 14, wherein the object comprises a wireless transceiver and a housing configured to be coupled to luggage or a bicycle.

18. The handheld computing device of claim 14, wherein the mobile computing device is a smart phone comprising a touch screen display.

19. A handheld computing device, comprising:
a relative position determination circuit to determine a relative position and orientation to a fixed location; and
a processing circuit to retrieve an absolute position of the fixed location from a database of geographic information and to calculate an absolute position for the mobile computing device based on the relative position and orientation to the fixed location and the absolute position of the fixed location.

20. A handheld computing device, comprising:
a magnetometer to generate an orientation of the mobile computing device relative to a reference direction;
a relative position determination circuit to determine a relative position to a fixed location; and
a processing circuit to retrieve an absolute position of the fixed location from a database of geographic information and to calculate an absolute position for the mobile computing device based on the orientation relative to the reference direction, the relative position to the fixed location and the absolute position of the fixed location.
